(19) United States
(12) Patent Application Publication
(10) Pub. No.: US 2015/0201040 A1
(43) Pub. Date: Jul. 16, 2015

(54) CLOUD-BASED BROWSER HISTORY

(71) Applicant: Google Inc., Mountain View, CA (US)

(72) Inventors: Bryan Christopher HORLING, Sunnyvale, CA (US); Vladislav Adzic, East Setauket, NY (US)

(73) Assignee: Google Inc., Mountain View, CA (US)

(21) Appl. No.: 13/779,703

(22) Filed: Feb. 27, 2013

Related U.S. Application Data
(60) Provisional application No. 61/707,701, filed on Sep. 28, 2012.

(51) Int. Cl. H04L 29/06

(52) U.S. Cl. CPC H04L 67/42

(57) ABSTRACT

A method includes receiving browsing data from the plurality of client devices associated with the user, receiving a request from one of the plurality of client devices to access the received browsing data, determining whether the request to access the received browsing data is a request to utilize the received browsing data for a task associated with the one of the plurality of client devices or a deletion request, wherein the deletion request is a request to delete a portion of the received browsing data and automatically deleting the portion of the received browsing data on the server and synchronizing the deletion across each of the plurality of client devices associated with the user when the request is determined to be a deletion request, otherwise providing access to the received browsing data to the one of the plurality of client devices.

### CROSS-REFERENCE TO RELATED APPLICATIONS

The present application claims the benefit of priority under 35 U.S.C. §119 from U.S. Provisional Patent Application Ser. No. 61/707,701 entitled “CLOUD-BASED BROWSER HISTORY,” filed on Sep. 28, 2012, the disclosure of which is hereby incorporated by reference in its entirety for all purposes.

### BACKGROUND

Users browsing the Internet may access a locally stored browsing history of a client device used for the browsing session. However, users routinely use several different computing devices throughout a day to browse the Internet. Therefore, it would be desirable to provide access to a user's aggregated browsing history on any device with which the user is associated, regardless of the device on which a part of the browsing history was created or the device from which the browsing history is requested to be viewed. However, synchronizing browsing data between multiple devices is inefficient and burdensome on the networks.

### SUMMARY

The subject disclosure relates generally to data management, and more particularly to managing browsing data of a user across a plurality of client devices associated with the user.

The subject disclosure relates to a machine-implemented method for managing browsing data of a user across a plurality of client devices associated with the user. The method includes receiving, at a server, browsing data from the plurality of client devices associated with the user, receiving a request from one of the plurality of client devices to access the received browsing data, determining whether the request to access the received browsing data is a request to utilize the received browsing data for a task associated with the one of the plurality of client devices or a deletion request, wherein the deletion request is a request to delete a portion of the received browsing data and automatically deleting the portion of the received browsing data on the server and synchronizing the deletion across each of the plurality of client devices associated with the user when the request is determined to be a deletion request, otherwise providing access to the received browsing data to the one of the plurality of client devices in response to the received request from the one of the plurality of client device, to access the received browsing data.

The subject disclosure also relates to a system for managing browsing data of a user across a plurality of client devices associated with the user. The system includes a collection module configured to receive, at a server, browsing data from the plurality of client devices associated with the user, a request module configured to receive a request from one of the plurality of client devices to access the received browsing data and determine whether the request to access the received browsing data is a request to utilize the received browsing data for a task associated with the one of the plurality of client devices or a deletion request, wherein the deletion request is a request to delete a portion of the received browsing data and a deletion module configured to automatically delete the portion of the received browsing data on the server. The system also includes a synchronization module, configured to synchronize the deletion across each of the plurality of client devices associated with the user when the request is determined to be a deletion request and a utilization module configured to provide access to the received browsing data to the one of the plurality of client devices, when the request to access the received browsing data is determined to be a request to utilize the received browsing data for a task associated with the one of the plurality of client devices.

The subject disclosure furthermore relates to a machine-readable medium comprising instructions stored therein, which when executed by the processors, cause the processors to perform operations that include receiving, at a server, browsing data from the plurality of client devices associated with the user, storing the received browsing data at the server and analyzing the stored browsing data at the server to generate aggregated browsing history, wherein the aggregated browsing history is based on the received browsing data. The operations also include receiving a request from one of the plurality of client devices to access the received browsing data, determining whether the request to access the received browsing data is a request to utilize the received browsing data for a task associated with the one of the plurality of client devices or a deletion request, wherein the deletion request is a request to delete a portion of the received browsing data and automatically deleting the portion of the received browsing data on the server and synchronizing the deletion across each of the plurality of client devices associated with the user when the request is determined to be a deletion request, otherwise providing access to at least one of the received browsing data or the aggregated browsing history, to the one of the plurality of client devices.

These and other aspects may provide one or more of the following advantages. The disclosed subject matter provides data transparency and control to a user. A user may access from one device data that the user generated when previously using another device. Other advantages include reducing the network overhead of the service.

It is understood that other configurations of the subject technology will become readily apparent from the following detailed description, where various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several implementations of the subject technology are set forth in the following figures.

FIG. 1 is a diagram of an exemplary system for managing browsing data of a user across a plurality of client devices associated with the user.

FIG. 2 illustrates a flow diagram of an example process for managing browsing data of a user across a plurality of client devices associated with the user.

FIG. 3 conceptually illustrates a flow diagram of an example process for managing browsing data of a user across a plurality of client devices associated with the user.

FIG. 4 conceptually illustrates an example of a system for managing browsing data of a user across a plurality of client devices associated with the user.

FIG. 5 conceptually illustrates an electronic system with which some aspects of the subject technology are implemented.

### DETAILED DESCRIPTION

In the following detailed description, numerous specific details are set forth to provide a full understanding of the present disclosure. It will be apparent, however, that the implementations of the present disclosure may be practiced without some of these specific details. In other instances, structures and techniques have not been shown in detail so as not to obscure the disclosure.

Methods and systems for managing browsing data of a user across a plurality of client devices associated with the user are provided herein. As a user browses the Internet on various client devices, browsing data (e.g., raw browsing data), is uploaded to a server, such as a cloud-based server. Concurrently, browsing data is also saved locally on the device on which the browsing session take place, to enable the user to have access to the browsing data when the device is off-line.

As the browsing data from various client devices is uploaded to the server, the browsing data may be stored at the server and analyzed. For example, the browsing data may be analyzed for browsing patterns, habits and preferences. Based on the analyzed browsing data, the cloud-based server may generate an aggregated browsing history for the user. The aggregated browsing history may include, but is not limited to, a user's favorites, most visited sites, most queried searches, browsing patterns and preferences, and other information.

As new browsing data is received at the cloud-based server, the browsing data is not automatically synchronized across (e.g., downloaded to) each associated client device. However, according to an aspect of the disclosed technology, some or all of the aggregated browsing history may be provided to a particular client device when the client devices requests to utilize the browsing data. That is, periodically, a client device associated with the user may need to utilize the browsing data for a task. For example, when a user is browsing the Internet, a browser program running on the client device may need to utilize the browsing data to facilitate a more efficient browsing session, by automatically completing the user's search terms. However, instead of utilizing the browsing data received at the server from the various client devices associated with the user (e.g., raw browsing data), the system may utilize the aggregated browsing history.

According to one aspect of the subject technology, when a user types “y” into a search bar of a client device that is connected to the Internet, the browser running on the client device may suggest, based on the aggregated browsing history, that the search is for “www.youtube.com.” The suggestion may be made when, based on the aggregated browsing history, the browser determines that “www.youtube.com” is the site the user usually looks for when a search starts with the letter “y.” The suggestion may also be reconciled with browsing data stored locally on the client device, to determine whether a different suggestion should be made based on the local data, or to determine a hierarchy of possible suggestions. To that end, the server is pinged for access to the aggregated browsing history in order to facilitate the automatic search completion task at the client device. Alternatively, the server may utilize the browsing data collected from the various client devices associated with the user, to make the suggestion to the requesting client device.

The aggregated browsing history is not, however, automatically provided to a client device associated with the user until a request to utilize browsing data is received from the device at the server. According to an aspect of the disclosed technology, the server provides the aggregated browsing history only to the device requesting to utilize the aggregated browsing history. As used herein, providing the aggregated browsing history may include causing the aggregated browsing history to download to a client device. There may be a communication that is sent ahead of or together with the aggregated browsing history to a client device asking whether the aggregated browsing history may be sent to the device.

According to another aspect, the server may provide access to the aggregated browsing history to the various other client devices associated with the user at some predetermined time intervals. For example, aggregated browsing history may be synchronized across various client devices once a day. The browsing data, however, is not pushed to or synchronized across the client devices associated with the user.

According to yet another aspect of the disclosed subject matter, a small portion of the browsing data may be made available to the various client devices associated with the user. For example, the last 20-50 visited pages may be provided to all of the client devices associated with the user, to enable the user to view a record of his or her browsing history and issue an instruction regarding a portion of the data, such as, for example, a deletion request. Thus, a small portion of the browsing data may be sent to the various client devices to facilitate certain tasks, such as a request to delete an entry from the browsing data. Some of the browsing data that is sent to the client devices from the server may be reconciled or merged with the local data that is stored on each client device. A full synchronization of the browsing data, across all of the client devices associated with the user, however, need not be performed.

As such, when a server or another entity at the system receives a request to access the browsing data from one of the client devices associated with a user, the server determines what kind of a request is received. That is, the server determines whether the request to access the received browsing data is a request to utilize the browsing data stored at the server for a task associated with the one of the plurality of client devices or a deletion request. The deletion request, as used herein, is a request to delete a portion of the browsing data.

When the request is determined to be a request to utilize the browsing data for a task associated with the one of the plurality of client devices, the system provides access to the browsing data to the one of the plurality of client devices. When the request is determined to be a deletion request, the system automatically deletes the portion of the browsing data on the server and synchronizes the deletion across each of the plurality of client devices associated with the user.

Thus, in a case the request is determined to be a deletion request, the system completes a synchronization across the client devices associated with the user. The deletion is synchronized across all of the devices, and causes each device to remove any local copies of the data corresponding to the deletion request, that might exist. Each client device with which the user is associated receives access to the updated received browsing data. The synchronization enables the user to have most up-to-date browsing data. In response to the deletion request, the cloud-based server pushes the updated browsing data to each client device associated with the user. The cloud-based server may then aggregate a new browsing history, corresponding to the deletion of a portion of the browsing data.

Any client device associated with the user may access the aggregated browsing history on demand and utilize the history for a task. However, when a user deletes a portion of his or her browsing data, the deletion is synchronized across every client device associated with the user. A centralized view of a user's browsing history is provided, which offers a consistent view from the user's perspective and a better user experience as the user uses several different devices to browse the Internet. A data repository is also provided, which may be used for data storage and personalization across various services and products, while supporting quick access to client data.

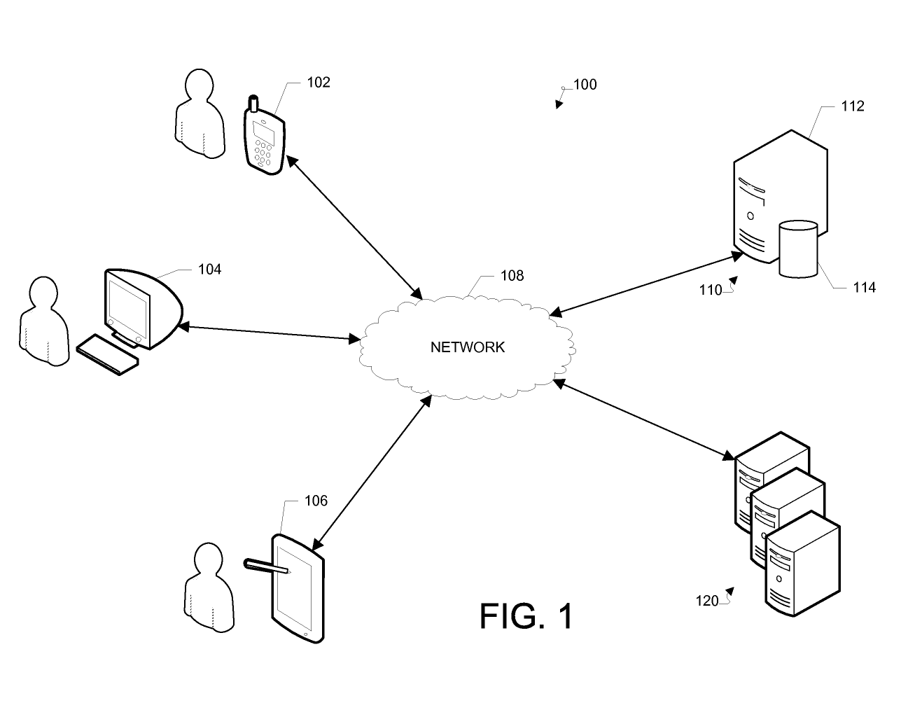

FIG. 1 illustrates an example client-server network that provides for managing browsing data of a user across a plurality of client devices associated with the user. A network 100 includes a number of electronic devices 102, 104 and 106 communicably connected to a server 110 by a network 108. Server 110 includes a processing device 112 and a data store 114. Processing device 112 executes computer instructions stored in data store 114, for example, instructions to collect received browsing data from a plurality of client devices associated with a user, instructions to store the browsing data, or instructions to analyze the browsing data to generate aggregated browsing history.

Data store 114 may store the received browsing data and aggregated browsing history of a user. Server 110 or application servers 120 may host an application within which some of the processes discussed herein are implemented. For example, server 110 or application servers 120 may determine whether a request received from one of the client device associated with a user is a request to utilize the user's browsing data for a task or a deletion request. The server 110 or application servers 120 may cause automatic deletion of browsing data on the server and the synchronization of the deletion across each client device associated with the user. Server 110 or application servers 120 may provide access to a user's browsing data when the request is to utilize the user's browsing data for a task. A task includes but is not limited to, for example, auto-completing a user's search query or web address entry.

In some example aspects, electronic devices or client devices, as used interchangeably herein, 102, 104 and 106 can be computing devices such as smartphones, PDAs, portable media players, tablet computers, televisions or other displays with one or more processors coupled thereto or embedded therein, or other appropriate computing devices that can be used for running a mobile application.

Electronic devices 102, 104, 106 may have one or more processors embedded therein or attached thereto, or other appropriate computing devices that can be used for accessing a host, such as server 110. In the example of FIG. 1, electronic device 102 is depicted as a smartphone, electronic device 104 is depicted as a tablet computer, and electronic device 106 is depicted as a PDA. A client is an application or a system that accesses a service made available by a server which is often (but not always) located on another computer system accessible by a network. Some client applications may be hosted on a website, whereby a browser is a client. Such implementations are within the scope of the subject disclosure, and any reference to client may incorporate a browser and reference to server may incorporate a website.

The system (e.g., hosted at server 110), collects a user's browsing data and stores it. The system may analyze the data to generate aggregated browsing history for a user. The aggregated browsing history may contribute to a summary of the user's activity. Aggregated browsing history may be periodically synchronized across the various devices associated with the user, to improve latency of various features that use the aggregated browsing history. A user may interact with the system with any of the electronic device 102, 104, 106. The users are clustered into one or more groups of users based on the collected user interaction data for each user by the application servers 120 or server 110. The browsing data and the aggregated browsing history may be stored in data store 114. Application servers 120 may determine whether to synchronize the browsing data. According to an aspect of the disclosed technology, the browsing data is synchronized only when the user request is a deletion request. Aggregated browsing history may be synchronized across the various client devices associated with the user by the application servers 120. Such synchronization may take place daily; not necessarily in response from a client device to utilize the browsing data.

Application servers 120 are in communication with the electronic devices 102-106 through network 108. Each electronic device 102, 104, 106 may be a client device or a host device. In some example aspects, server 110 can be a single computing device such as a computer server. In other implementations, server 110 can represent more than one computing device working together to perform the actions of a server computer (e.g., cloud computing). The server 110 may host the web server communicationally coupled to the browser at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

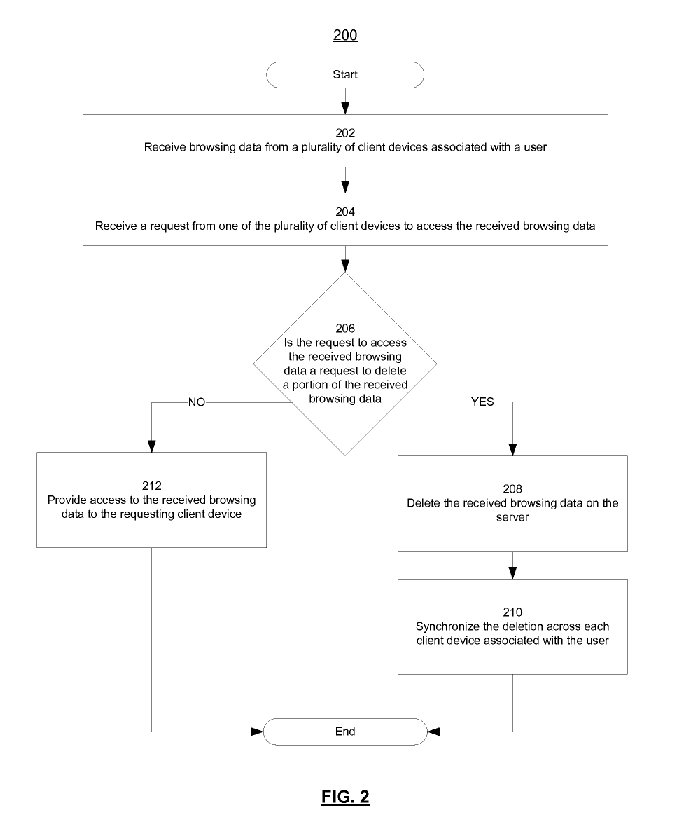

FIG. 2 illustrates a flow diagram of an example process 200 for managing browsing data of a user across a plurality of client devices associated with the user. At block 202, browsing data is received from a plurality of client devices associated with the user. The client devices may be any one or more of the client devices 102-106. The server may be a cloud-based server. Browsing data is received from client devices as a user engages a browsing application running on the client device. The browsing data may be sent to the server in real time, as the data is generated on the client device. Alternatively, the data may be sent to the server in batches. For example, browsing data may be sent from a client device to a server every 5 minutes or every hour. The browsing data may be stored at the server, and may be contemporaneously saved locally on the client device.

At block 202 the server receives a request form one of the plurality of client devices to access the received browsing data. The request may be an explicit request from the client device to receive access to the browsing data. Alternatively, the request may be inferred from an action or a task that the client device or a browsing application running on the client device performs. For example, the browsing application may need to auto-complete a search entry or a URL entry or to suggest auto-completion choices to the user. In order to auto-complete the entry or make auto-completion suggestions, the browsing application may need to communicate with the server, to access certain information that is necessary in order to complete such tasks. To that end, a request is sent to the server, for access to the browsing data that is stored at the server.

At block 206, the system determines whether the request to access the received browsing data is a request to delete a portion of the received browsing data or a request to utilize the browsing data for a task associated with client device sending the request. According to one aspect, a request to access the received browsing data, whether the request is to delete a portion of the received browsing data or to utilize the browsing data for a task associated with client device sending the request, may need to be authenticated for proper permissions to take those actions. When, at block 206, the request is determined to be a request to delete a portion of the browsing data, the system automatically deletes the portion of the browsing data marked by the request at the server at block 208. The system also synchronizes the deletion across every client device associated with the user at block 210.

When deleting a portion of the data, the user may further specify that browsing data entries that are similar to the data marked for deletion should also be deleted. The server may engage in additional processes to identify the similar entries, delete the similar entries at the server, and synchronize the deletion across the various client devices associated with the user. A user may enter any type of deletion criteria. For example, a user may select a time range, a topic, a theme or a key word, and matching entries would be deleted on the client devices associated with the user, according to the methods disclosed herein.

When, at block 206, the request is determined not to be a request to delete a portion of the browsing data, the system provides access to the received browsing data to the requesting client device, at block 212. For example, the system may allow the client device to utilize the browsing data for an auto-completion task or another task requiring the use of the browsing data. Thus, the browsing data is not synchronized across the various client devices associated with the user unless a client device is attempting to delete a portion of the browsing data. Also, no other client device associated with the user automatically receives the browsing data.

When a client device utilizes the browsing data of the user, and the server provides the client device with access to the browsing data, the data may be sent to the requesting client device. The browsing data may be further reconciled with the data that is stored locally, on the device, when executing a particular task. The local data and the browsing data stored at the server may be merged, in order to facilitate the completion of the task.

As previously discussed, however, according to one aspect of the disclosed subject matter, a small portion of the browsing data may be made available to the various client devices associated with the user. For example, the last 20-50 visited pages may be provided to all of the client devices associated with the user, to enable the user to see the data and issue an instruction regarding the data, such as, for example, a deletion request. Thus, a small portion of the browsing data may be sent to the various client devices to facilitate certain tasks, such as selecting data for deletion.

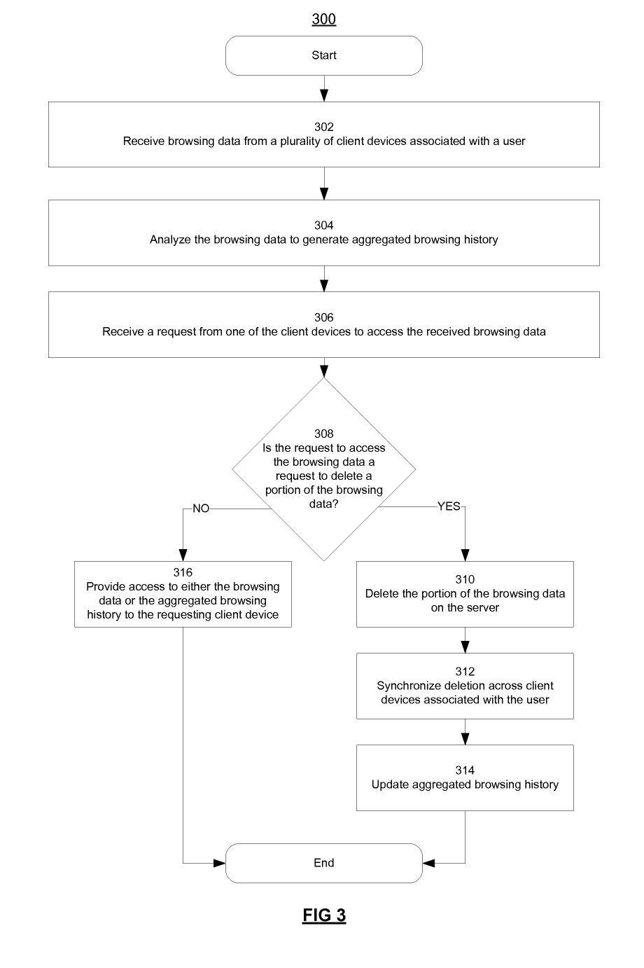

FIG. 3 illustrates a flow diagram of an example process 300 for managing browsing data of a user across a plurality of client devices associated with the user. The process starts and at block 302, a server receives browsing data from a plurality of client devices associated with a user. The server may be a cloud-based server. The server may store the browsing data upon receiving the data. The server, therefore, acts as a centralized repository for a user's browsing data that is generated on a plurality of client devices with which the user is associated.

The server or another entity depicted on the network 100 analyzes the received browsing data to generate an aggregated browsing history for the user. For example, the browsing data may be analyzed for browsing patterns, habits and preferences. The aggregated browsing history may serve as a summary of the user's activities. The aggregated browsing history may include, but is not limited to, a user's favorites, most visited sites, most queried searches, browsing patterns and preferences, and other information. The aggregated browsing history is based on the received browsing data but is processed to highlight certain highlight's of a user's browsing behavior.

At block 302, the server receives a request from one of the client devices associated with the user, to access the received browsing data. The request to access the browsing data, as stated previously, may be an explicit request to access the data or an inferred request. For example, as previously discussed, in an auto-completion scenario, when a user types “y” into a search bar of a client device that is connected to the Internet, the browser running on the client device may need to use the browsing data stored on the server in order to suggest a site the user usually browses to when typing “y” into a search box. Instead of only relying on the data that is stored locally on the requesting client device, the device may ask the server for suggestions because the server has a wider range of data. The data on the server is reflects entries received from multiple devices used by the user. Thus, the request may be inferred based on an action occurring on the client device.

At block 304, the server or another entity on the network determines whether the request to access the browsing data is a request to delete a portion of the browsing data or a request to utilize the browsing data for a task on the client device. When the request for access is a deletion request, there is a deletion marker embedded in the request that identifies a portion of the browsing data that is marked for deletion. For example, the user may select a browsing entry from a local browsing history and mark the entry for deletion. The deletion request is communicated to the server which, in turns, determines the type of access request the client device has sent. Tasks or actions selected by a user locally at the client device, therefore, are communicated to the server, in order to coordinate and facilitate the completion of the tasks or actions at the device.

When the request to access the browsing data is determined to be a deletion request, the server deletes the portion of the browsing data on the server at block 310. Contemporaneously, the corresponding local data is also deleted on the client device. At block 312, the deletion is synchronized across the various client devices associated with the user. To that end, received browsing data is deleted from the server and also from every other client device associated with the user, as soon as the data is marked for deletion.

Because aggregated browsing history is based on the received browsing data, the aggregated browsing history may be updated, in response to the deletion, at block 314. The aggregated browsing history may be updated by removing the portion of the received browsing data that is repeated in the aggregated browsing history. Furthermore, any derivative information that is based on the deleted portion of the received browsing data may likewise be updated to reflect the deletion. The deleted information may appear directly or indirectly in the aggregated browsing history, therefore, updating the aggregated browsing history depends on how the deleted data is represented in the history. The updated aggregated browsing history may also be synchronized across the various client devices associated with the user. For example, such synchronization may be carried out in pre-determined time intervals, such as once a day.

When the request to access the browsing data is determined to be a request other than a deletion request, for example, a request to utilize the browsing data for a task associated with the client device, the server provides access to either the browsing data or the aggregated browsing history to the requesting client device, at block 316. Only the requesting client device gains access to the browsing data or the aggregated browsing history. The request to utilize the browsing data for a task associated with the requesting client device may be generated when the client device tries to auto-complete a browsing entry. The client device seeks to utilize the browsing data or the aggregated browsing history to determine how the entry should be completed. The aggregated browsing history may be a better source for the auto-completion, as the aggregated browsing history is a processed compilation of the user's browsing data.

For example, as discussed previously, when a user types “y” into a search field or the URL field, the client device may request an auto-completion suggestion from the server. Such suggestion may be based on the aggregated browsing history. The server may determine that “www.youtube.com” is the site the user usually looks for when a search starts with the letter “y.” The suggestion may also be reconciled with browsing data stored locally on the client device, to determine whether a different suggestion should be made based on the local data, or to determine a hierarchy of possible suggestions. To that end, the server is pinged for access to the aggregated browsing history in order to facilitate the automatic search completion task at the client device. Alternatively, the server may utilize the browsing data collected from the various client devices associated with the user, to make the suggestion to the requesting client device. Providing access to either the browsing data or the aggregated browsing history may include sending the browsing data or the aggregated browsing history to the requesting client device.

According to an aspect of the disclosed subject matter, the aggregated browsing history may be synchronized across the various client devices associated with the user. Synchronizing the aggregated browsing history may occur at pre-determined time intervals such as, for example, once a day.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing display. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

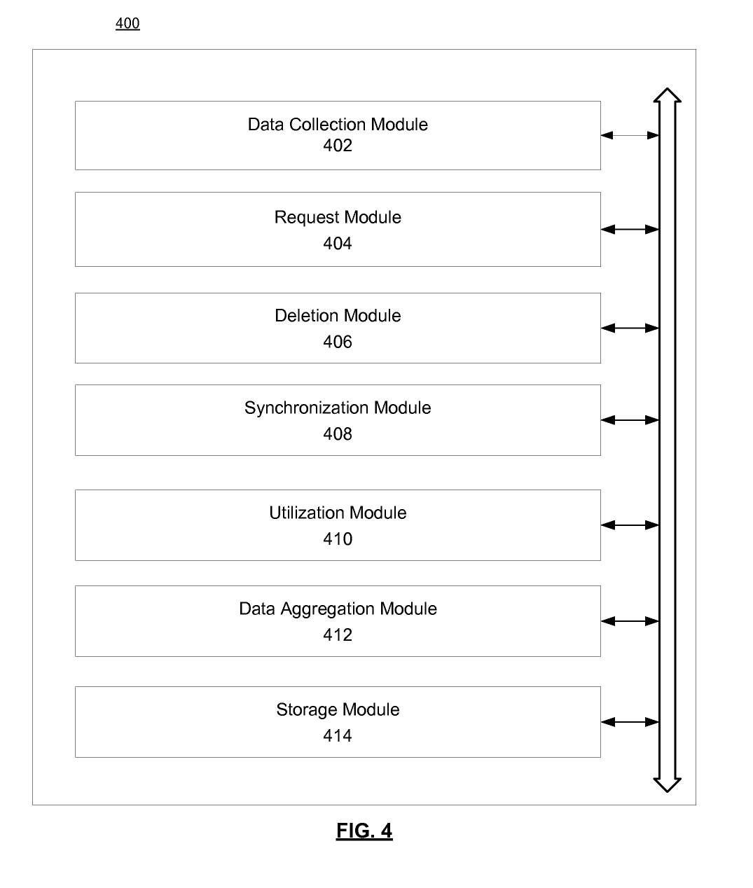

FIG. 4 illustrates an example of system 400 for managing browsing data of a user across a plurality of client devices associated with the user, in accordance with various aspects of the subject technology. System 400 comprises a data collection module 402, a request module 404, a deletion module 406, a synchronization module 408, and a utilization module 410. The system may also include a data aggregation module 412 and a storage module 414.

The data collection module 402 is configured to receive, at a server, browsing data from the plurality of client devices associated with the user. The request module 404 is configured to receive a request from one of the plurality of client devices to access the received browsing data and determine whether the request to access the received browsing data is a request to utilize the received browsing data for a task associated with the one of the plurality of client devices or a deletion request, wherein the deletion request is a request to delete a portion of the received browsing data. The deletion module 406 is configured to automatically delete the portion of the received browsing data on the server.

The synchronization module 408 is configured to synchronize the deletion across each of the plurality of client devices associated with the user when the request is determined to be a deletion request. The utilization module 410 is configured to provide access to the received browsing data to the one of the plurality of client devices, when the request to access the received browsing data is determined to be a request to utilize the received browsing data for a task associated with the one of the plurality of client devices. The utilization module 410 may further configured to send the received browsing data to the one of the plurality of client devices. The data aggregation module 412 is configured to analyze the received browsing data at the server to generate aggregated browsing history, wherein the aggregated browsing history is based on the received browsing data. The storage module 414 is configured to store the received browsing data at the server.

These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

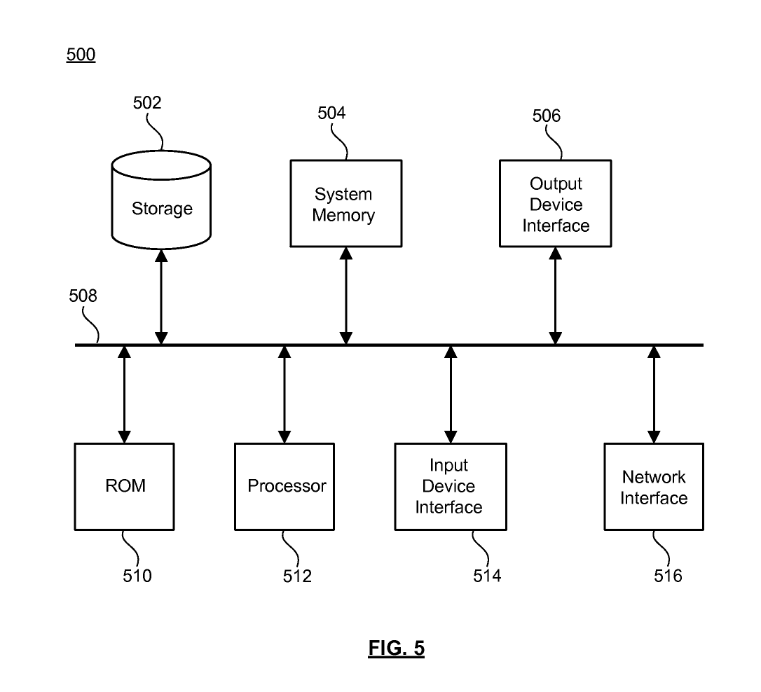

FIG. 5 conceptually illustrates an electronic system with which some aspects of the subject technology are implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as televisions or other displays with one or more processors coupled thereto or embedded therein, or other appropriate computing devices that can be used for running an application. Some implementations include devices such as a touch screen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a device having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of steps in the processes disclosed is an illustration of exemplary approaches. Based upon design preferences, it is understood that the specific order or hierarchy of steps in the processes may be rearranged, or that some illustrated steps may not be performed. Some of the steps may be performed simultaneously. For example, in certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

1. A computer-implemented method for managing browsing data of a user across a plurality of client devices associated with the user, the method comprising:
receiving, at a server, browsing data from the plurality of client devices associated with the user;
receiving a request from one of the plurality of client devices to access the received browsing data;
determining whether the request to access the received browsing data is a request to utilize the received browsing data for a task associated with the one of the plurality of client devices or a deletion request, wherein the deletion request is a request to delete a portion of the received browsing data; and
automatically deleting the portion of the received browsing data on the server and synchronizing the deletion across each of the plurality of client devices associated with the user when the request is determined to be a deletion request, otherwise providing access to the received browsing data to the one of the plurality of client devices in response to the received request from the one of the plurality of client device, to access the received browsing data.

2. The computer-implemented method of claim 1, wherein providing access to the received browsing data to the one of the plurality of client devices comprises sending the received browsing data to the one of the plurality of client devices.

3. The computer-implemented method of claim 1, further comprising:
storing the received browsing data at the server.

4. The computer-implemented method of claim 1, further comprising:
analyzing the received browsing data at the server to generate aggregated browsing history, wherein the aggregated browsing history is based on the received browsing data.

5. The computer-implemented method of claim 4, wherein providing access to the received browsing data to the one of the plurality of client devices, when the request is determined to be a request to utilize the received browsing history for a task associated with the one of the plurality of client devices comprises providing access to the aggregated browsing history.

6. The computer-implemented method of claim 5, wherein providing access to the aggregated browsing history comprises sending the aggregated browsing history to the one of the plurality of client devices.

7. The computer-implemented method of claim 4, wherein automatically deleting the portion of the received browsing data on the server and synchronizing the deletion across each of the plurality of client devices associated with the user when the request is determined to be a deletion request comprises deleting from the aggregated browsing history data corresponding to deleted portion of the received browsing data.

8. The computer-implemented method of claim 4, further comprising:
synchronizing the aggregated browsing history across each client device in the plurality of client devices.

9. The computer-implemented method of claim 4, wherein the aggregated browsing history contributes to a summary of the user's activity associated with the plurality of client devices.

10. The computer-implemented method of claim 4, wherein, automatically deleting the portion of the received browsing data on the server and synchronizing the deletion across each of the plurality of client devices associated with the user further comprises:
updating the aggregated browsing history to correspond to the deletion in the received browsing data.

11. The computer-implemented method of claim 10, further comprising:
synchronizing the updated aggregated browsing history across the plurality of client devices associated with the user.

12. A system for managing browsing data of a user across a plurality of client devices associated with the user, the system comprising:
one or more processors; and
a memory comprising processor-executable instructions, which when executed by the one or more processors cause the system to:
receive, at a server, browsing data from the plurality of client devices associated with the user;
receive a request from one of the plurality of client devices to access the received browsing data;
determine whether the request to access the received browsing data is a request to utilize the received browsing data for a task associated with the one of the plurality of client devices or a deletion request, wherein the deletion request is a request to delete a portion of the received browsing data;
automatically delete the portion of the received browsing data on the server and synchronize the deletion across each of the plurality of client devices associated with the user when the request is determined to be a deletion request; and
provide access to the received browsing data to the one of the plurality of client devices, when the request to access the received browsing data is determined to be a request to utilize the received browsing data for a task associated with the one of the plurality of client devices.

13. The system of claim 12,
wherein the processor-executable instructions, when executed by the one or more processors, cause the system to analyze the received browsing data at the server to generate aggregated browsing history, wherein the aggregated browsing history is based on the received browsing data.

14. The system of claim 13, wherein the processor-executable instructions, when executed by the one or more processors, cause the system to send the received browsing data to the one of the plurality of client devices.

15. The system of claim 13,
wherein the processor-executable instructions, when executed by the one or more processors, cause the system to store the received browsing data at the server.

16. A machine-readable medium comprising instructions stored therein, which when executed by the processors, cause the processors to perform operations comprising:
receiving, at a server, browsing data from the plurality of client devices associated with the user;
storing the received browsing data at the server;
analyzing the stored browsing data at the server to generate aggregated browsing history, wherein the aggregated browsing history is based on the received browsing data;
receiving a request from one of the plurality of client devices to access the received browsing data;
determining whether the request to access the received browsing data is a request to utilize the received browsing data for a task associated with the one of the plurality of client devices or a deletion request, wherein the deletion request is a request to delete a portion of the received browsing data; and
automatically deleting the portion of the received browsing data on the server and synchronizing the deletion across each of the plurality of client devices associated with the user when the request is determined to be a deletion request, otherwise providing access to at least one of the received browsing data or the aggregated browsing history, to the one of the plurality of client devices.

17. The machine-readable medium of claim 16, wherein providing access to at least one of the received browsing data or the aggregated browsing history comprises sending the at least one of the received browsing data or the aggregated browsing history to the one of the plurality of client devices.

18. The machine-readable medium of claim 16, wherein automatically deleting the portion of the received browsing data on the server and synchronizing the deletion across each of the plurality of client devices associated with the user when the request is determined to be a deletion request comprises deleting from the aggregated browsing history data corresponding to deleted portion of the received browsing data.

19. The machine-readable medium of claim 16, the operations further comprising:
synchronizing the aggregated browsing history across each client device in the plurality of client devices.

20. The machine-readable medium of claim 16, wherein the aggregated browsing history contributes to a summary of the user's activity associated with the plurality of client devices.

21. The machine-readable medium of claim 16, wherein, automatically deleting the portion of the received browsing data on the server and synchronizing the deletion across each of the plurality of client devices associated with the user further comprises:
updating the aggregated browsing history to correspond to the deletion in the received browsing data.

22. The machine-readable medium of claim 21, the operations further comprising:
synchronizing the updated aggregated browsing history across the plurality of client devices associated with the user.
